(19) United States
(12) Patent Application Publication
(10) Pub. No.: US 2019/0277047 A1
(43) Pub. Date: Sep. 12, 2019

(54) SYSTEM AND METHOD OF ASSEMBLING AND INSTALLING COMMERCIAL ROOFING

(71) Applicant: Innovatech, LLC, Kanarraville, UT (US)

(72) Inventors: James Barlow, Colorado, AZ (US); James Harker, Colorado City, AZ (US)

(73) Assignee: Innovatech, LLC, Kanarraville, UT (US)

(21) Appl. No.: 16/295,605

(22) Filed: Mar. 7, 2019

Related U.S. Application Data
(60) Provisional application No. 62/639,562, filed on Mar. 7, 2018.

(51) Int. Cl. E04G 21/32; A62B 35/00

(52) U.S. Cl. CPC E04G 21/3214; A62B 35/0093; A62B 35/0068

(57) ABSTRACT

A construction roofing safety anchoring assembly and method that permits a roofing construction worker to harness himself or herself to a stable, yet movable, rooftop anchor. The anchoring assembly features a mobile safety anchor having a safety harness coupled to a retractable cable and counterweighted anchoring assembly, wherein the assembly automatically and instantly acts to impede and stop any accidents or falls experienced by the rooftop worker. The safety anchoring assembly and method thus allows the worker to engage in unrestricted rooftop work efforts while the worker is also afforded substantially less risk of fall or injury.

### CROSS-REFERENCE TO RELATED APPLICATIONS

This application claims the benefit of U.S. Provisional Application Ser. No. 62/639,562, filed on Mar. 7, 2018, which is incorporated herein by reference.

### TECHNICAL FIELD

The present disclosure relates to commercial construction. More particularly, the present disclosure relates to a system and method of providing enhanced safety for commercial construction rooftop workers via an easily portable counterweighted anchoring and safety harness assembly.

### BACKGROUND

Building construction has always been, and continues to be, a necessary, yet inherently dangerous, industry. Heavy materials, large equipment, and heights all add to the intrinsic risk of this industry. The dangers are particularly true and salient for the roofing industry. When installing roofing, it is not uncommon to have many workers on the roof level, where they are interacting with dangerous components and with each other at dangerous heights. The more workers on the roof, the higher the odds of an accident. In an effort to reduce these risks and reduce the frequency of accidents and injury, special safety measures have been implemented for roof workers. Such measures include individual worker safety harnesses. Yet, while the risk is lowered, accidents still occur. Further, such safety measures slow the process of roof installation and impede building efficiency, as each construction worker on the roof must ensure that the appropriate safety measures are complied with and completed. This may include releasing a first strap while relocating to a new working position, and then securing a second strap. If only one strap is used by a worker, the worker risks falling when relocating to a new position on the roof. Each of these measures involve risk, time, and thereby reduce efficiency and/or safety. Further, equipment must be hoisted to those workers on the roof. Cranes or other devices lift such materials to the roof, wherein the cranes create a new danger when delivering materials and interacting with or influencing the movements of the workers on the roof.

There is a clear, continuing need for a system to reduce the risks posed in roof construction and installation work, while simultaneously promoting an increase in the efficiency of assembly and roof installation. The present invention seeks to address these and other problems. Specifically, during construction of a building, such as a large warehouse, the assembly of the present invention may be positioned to act as a fall protection system to reduce the likelihood and number of fall accidents, and in the event of an actual construction worker fall, the present invention will act as a fall arrest anchor and restraint system.

### SUMMARY OF EXAMPLE EMBODIMENTS

In one embodiment, a mobile safety anchor system for roofing construction comprises a ride-on tractor, an unrestricted swiveling boom mounted atop the tractor, two opposing counterweighted swivel arms, with one of these swivel arms forming a personal worker user safety anchoring system comprising a retractable safety cable linked to a weighted fall arm anchor, wherein the opposing swivel arm forms an equal counterweight and thereby enhances stability when the emergency safety mechanisms of the system are activated.

In one embodiment, a mobile safety anchor system also features a swivel plate atop the swivel frame with a number of fixed circular openings therein which allow an accompanying swivel pin to be placed into the hole of the swivel plate to secure the swivel boom and fall arms in an immobile posture. Securing the swivel boom can facilitate the operation of hoisting and general transport and movement of the construction roofing safety system itself to new construction sites and to different work areas at the same worksite.

In one embodiment, a mobile safety anchor system for roofing construction comprises a ride-on tractor, a swiveling boom mounted to the tractor having a first arm and a second arm, wherein the first arm is weighted and the second arm comprises one or more penetrating protrusions for penetrating the roof and preventing movement of the ride-on tractor, thereby anchoring a user.

### BRIEF DESCRIPTION OF THE DRAWINGS

Some embodiments of the present invention are illustrated as an example and are not limited by the figures of the accompanying drawings or by the depiction in the accompanying photo page. The figures and photo page are illustrative of invention functionality and are not necessarily to actual scale.

FIG. 1 is a top, right perspective view of a safety anchoring system for roofing construction in a deployed position;

FIG. 2 is a back, right perspective of a safety anchoring system for roofing construction in a deployed position;

FIG. 3 is a bottom, right perspective view of a safety anchoring system for roofing construction in a deployed position;

FIG. 4 is a left side elevation view of a safety anchoring system for roofing construction in a deployed position, the right side being a mirror image thereof;

FIG. 5 is a top plan view of a safety anchoring system for roofing construction in a deployed position;

FIG. 6 is a rear elevation view of a safety anchoring system for roofing construction in a deployed position;

FIG. 7 is a front elevation view of a safety anchoring system for roofing construction in a deployed position;

FIG. 8 is a bottom plan view of a safety anchoring system for roofing construction in a deployed position;

FIG. 9 is a side elevation view of a safety anchoring system for roofing construction in a non-deployed position;

FIG. 10 illustrates a safety anchoring system in use on a roof in a deployed position; and

FIG. 11 illustrates the penetrating protrusions of the safety anchoring system penetrated through roofing.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier herein, there is a need for a safety system that reduces the risks posed in roof construction and installation work, while simultaneously promoting an increase in the efficiency of assembly and roof installation. The construction rooftop safety anchoring system and method disclosed herein solves these needs and others. Specifically, it is an improvement over current mobile personal worker fall protection systems.

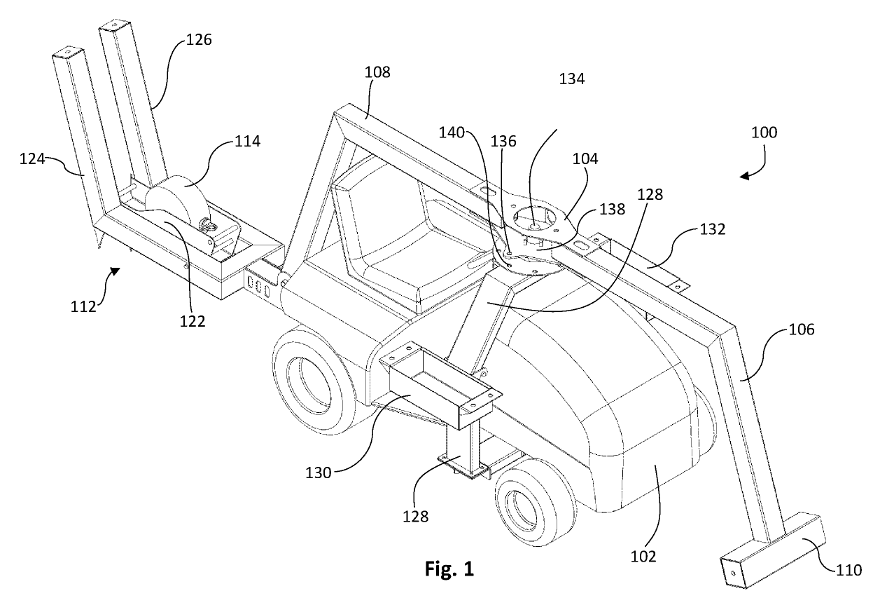

As depicted in FIG. 1, the mobile safety anchor system 100 for roofing construction comprises a ride-on tractor 102, which allows for easy transportation of the components of the mobile safety system while also serving to stow some of the individual worker's tools and fasteners. The mobile safety anchor system 100 is designed to operate primarily on a horizontal plane of a corrugated steel deck rooftop or mezzanine structure, wherein the entirety of the mobile safety anchor system 100 poses sufficient mass to serve as an anchorage.

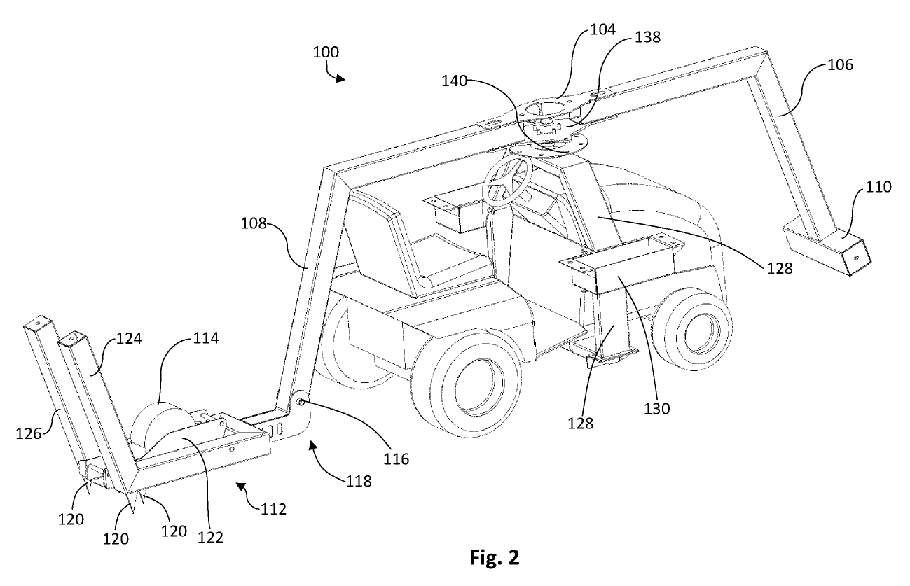

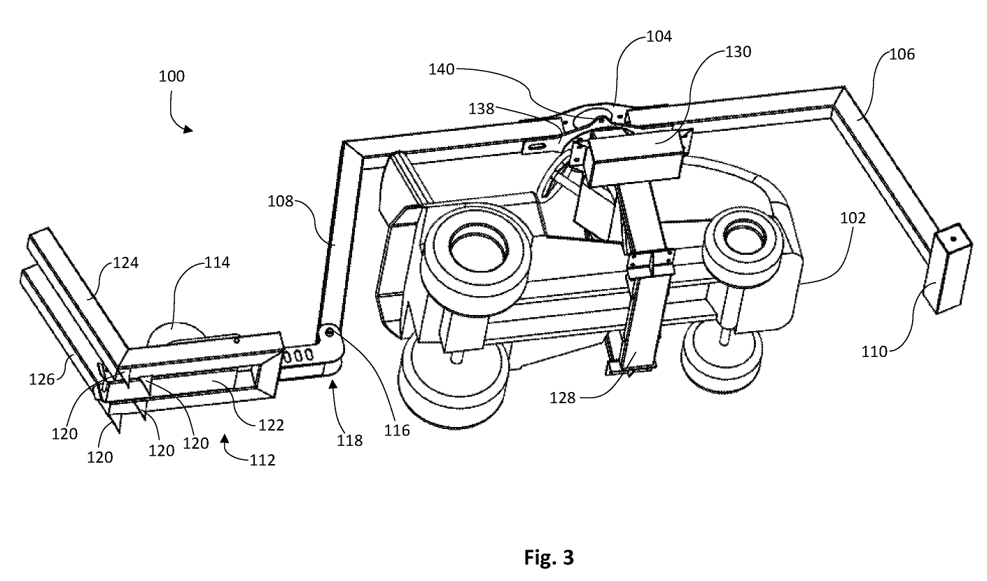

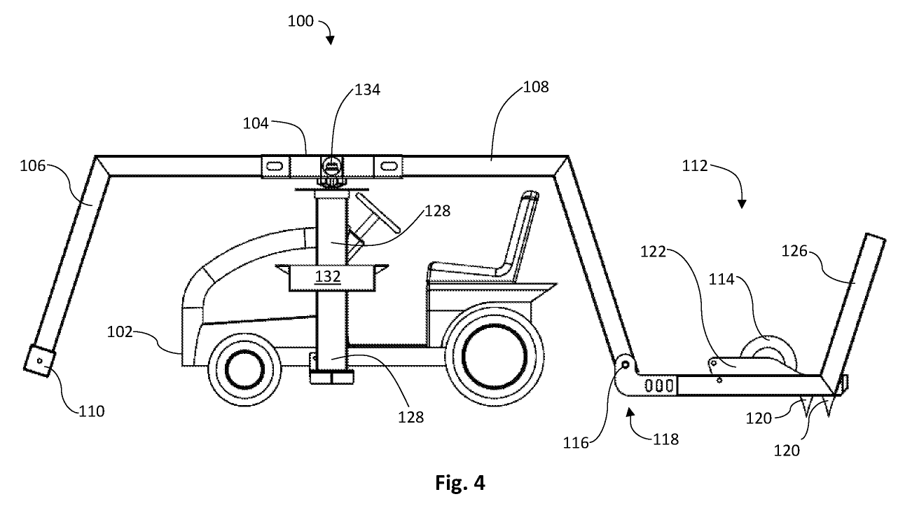

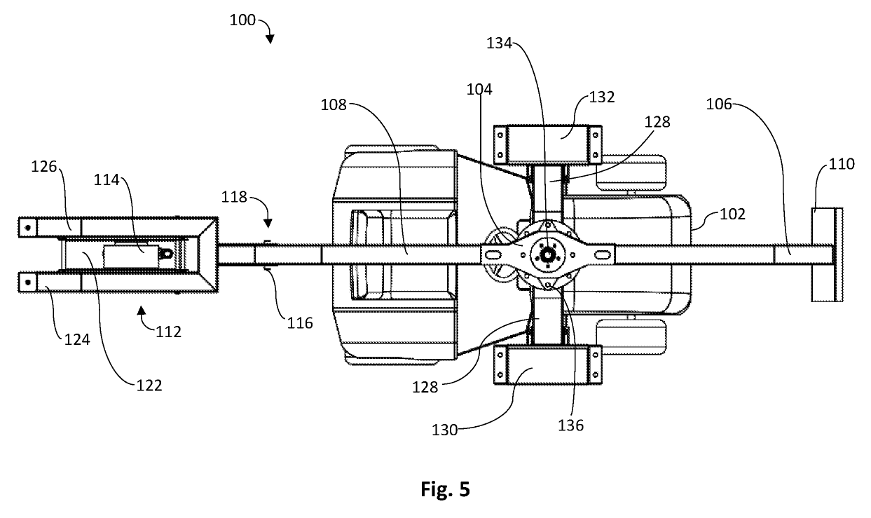

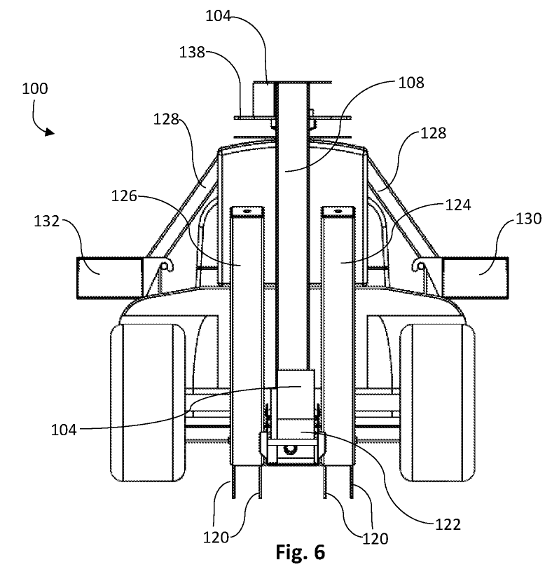

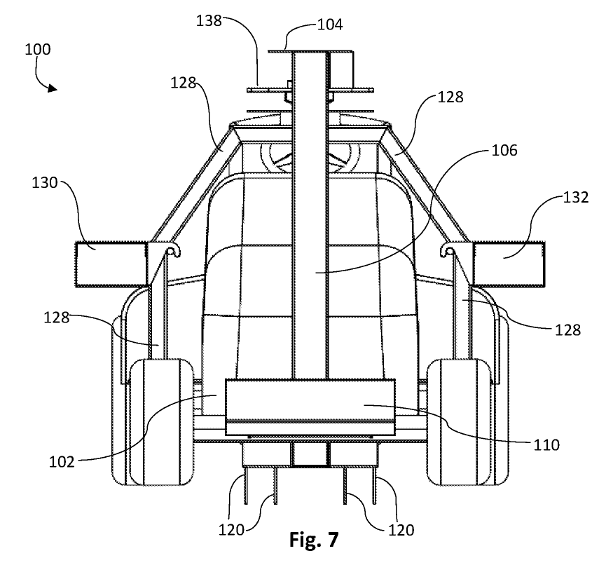

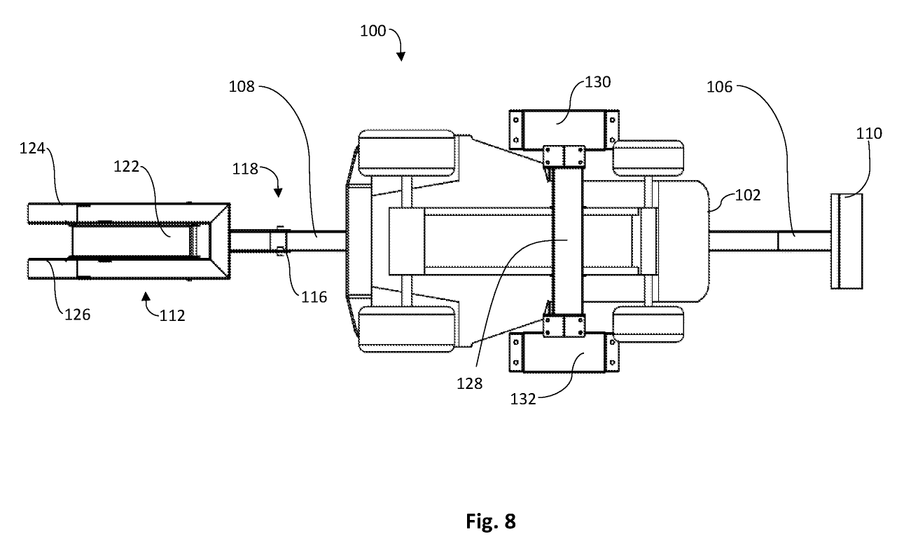

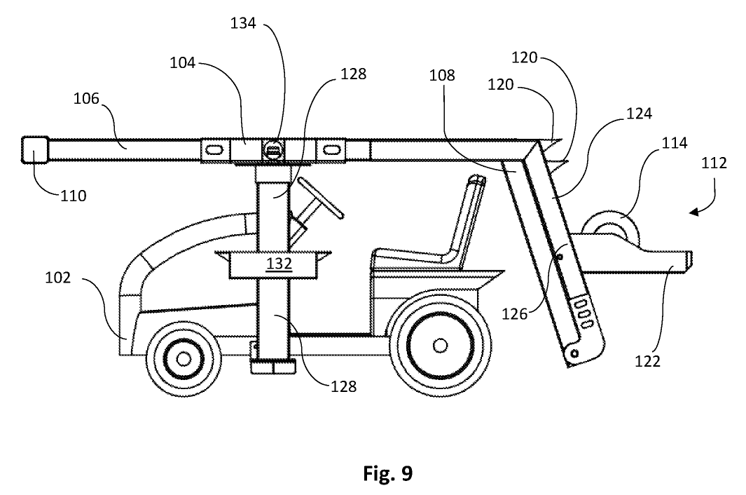

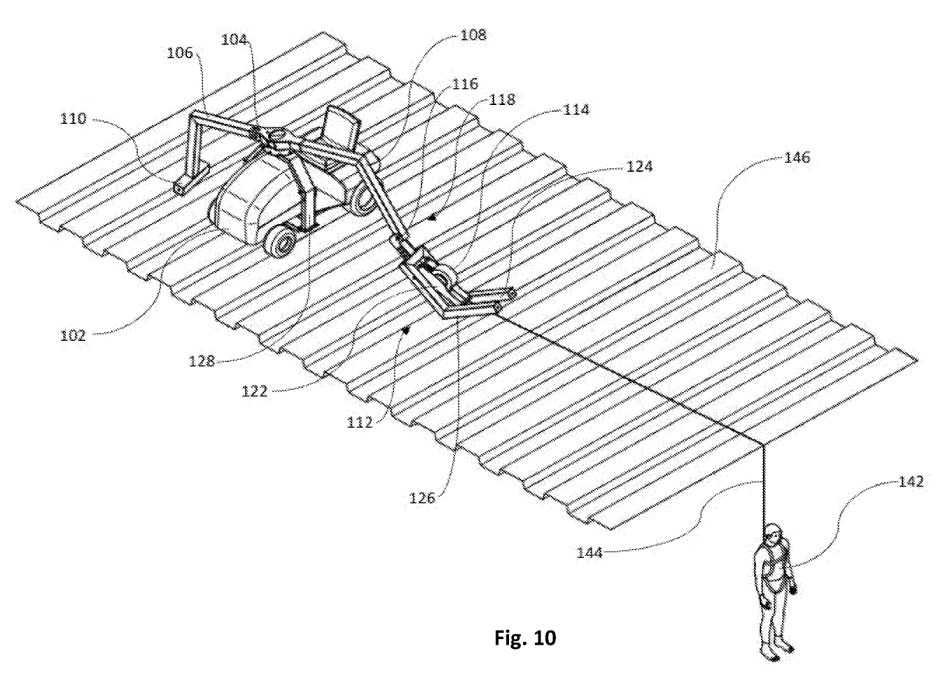

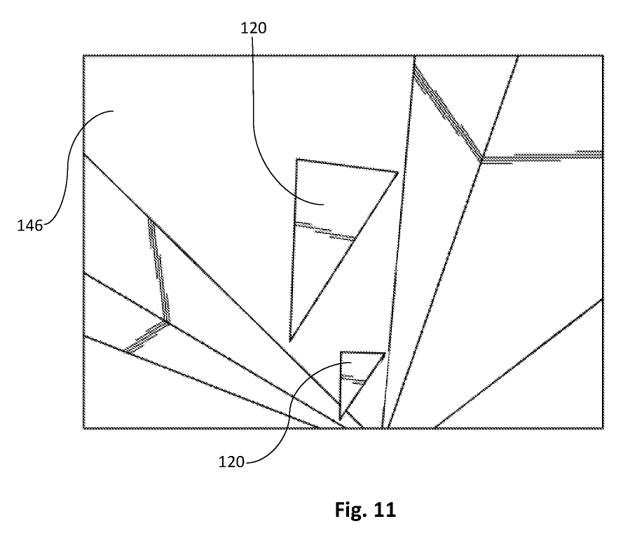

As shown in FIGS. 1-9, the mobile safety anchor system 100 comprises the ride-on tractor 102, a swivel boom 104 secured to the top of the tractor 102, a first arm 106 and a second arm 108 both coupled to the swivel boom 104. The swivel boom 104 allowing the first and second arms 106, 108 to rotate around the tractor 102. The first arm 106 comprises a counterweight 110 on its distal end. The second arm 108 comprises a fall arm assembly 112, the fall arm assembly 112 comprising a retractable spooling device 114, a hinge 116 creating a fulcrum point 118, and one or more penetrating protrusions 120. Referring to FIG. 9, in a non-deployed position, the fall arm assembly 112 is adjacent to second arm 108. The retractable spooling device 114 is secured in a spooling device tray 122, which is secured to one or more fall arms 124, 126 (best seen in FIG. 1). A worker is then tethered to the retractable spooling device 114 when positioned on a roof. As the worker works on the roof, the swivel boom 104 allows the worker freedom of movement in 360 degrees. The fall arms 124, 126 are weighted sufficiently to remain atop and adjacent to the second arm 108. If a worker falls from the roof, the tether reaches the end of the retractable spooling device 114, which exerts a pulling force on the fall arms 124, 126. The momentum causes fall arms 124, 126 to pivot on hinge 116, causing the fall arms 124, 126 to fall to the roof. When the fall arms 124, 126 impact the roof, the one or more penetrating protrusions 120 (e.g., blades) penetrate the roof, as shown in FIGS. 10-11. The penetrating protrusions 120 prevent the tractor 102 from rolling or otherwise moving, the tractor 102 serving as a weighted anchor to support a person. As shown, the spooling device tray 122 may be pivotably coupled to the fall arms 124, 126, allowing it to remain in a horizontal position regardless of the position of the fall arms 124, 126.

Referring again to FIG. 9, when the fall arms 124, 126 are in the non-deployed position, the first arm 106 and counterweight 110 are sufficient to offset the weight of the second arm 108 and fall arm assembly 112. This facilitates easy rotation of the arms 106, 108 on swivel boom 104. The arms 106, 108 are of a sufficient length so as to provide clearance suitable to allow both arms 106, 108 and the fall arm assembly 112 to rotate completely around the tractor 102.

The swivel boom 104 is coupled to the tractor 102 via frame 128. As shown, the swivel boom 104 is ideally positioned around the center of the tractor 102, although that positioning is not required. The frame 128 straddles each opposing lateral side of the tractor 102 and may be bolted, welded, or otherwise secured to the frame or chassis of the tractor 102. The frame 128 may have one or more trays 130, 132 coupled thereto for storage of tools or other components.

In one embodiment, the axle 134 connecting the swivel boom 104 with the frame 128 may be lubricated with fluids of differing viscosity, to promote or reduce the inertia of the swivel boom 104 and/or frictional resistance of the boom 104 to movement. In one embodiment, the inertia of the swivel boom 104, and/or frictional resistance of the swivel boom 104 to movement, may be manipulated by setting or adjusting the frictional tension of the component parts of the axle 134 against each other or, alternatively or in addition, through the application of pads or a sleeve (e.g., of thin gauge, non-flammable natural or synthetic elastomeric materials) around the axle 134 to adjust the inertial characteristics and/or frictional resistance of the swivel boom 104 to movement. The self-retracting spooling device 114 that couples the worker to the swivel boom 104 creates sufficient tension that ordinarily inhibits over-travel of the swivel boom 104. However, the freedom of movement of the assembly, including swivel boom 104 (with first arm 106 and second arm 108), can be set to match the desired movement characteristics of the user, for example, to allay potential concerns that the arms, in motion, may continue to move to an undesired extent once worker movement on the roof has stopped.

In one embodiment, one or more coiled springs (not shown) may be linked between the swivel boom 104 and the fall arm assembly 112. In one embodiment, this linkage is located at or below (distal to) the level of the spooling device tray 122. In one embodiment, one or more dashpot shock absorbers (dampers) are used in alternative or in conjunction with the one or more coiled springs. A coiled spring, or shock absorber, may be coupled separately between the swivel boom 104 extending to each separate arm 106, 108, or alternatively, a coiled spring or shock absorber may be coupled between the swivel boom 104 the fall arm assembly 112. The tension of a coiled spring or shock absorber will facilitate slowing and stopping the movement of a worker in a potential fall incident, and further, may serve to facilitate recovering the fallen worker and resetting the fall arm assembly 112 to its initial resting position weighted against the second arm 108 (FIG. 9).

In general operation, as shown in FIGS. 10-11, the worker 142 hooks a carabiner to the safety cable 144 of the spooling device 114. The spooling device 114 may be auto-retractable and may further comprise braking mechanisms to slow the fall of the worker 142. Example braking systems are found in auto-belay devices and use friction or magnetism (e.g., U.S. Pat. No. 8,490,751). The spooling device tray 122 lies between the weighted arms 124, 126 of the fall arm assembly 112 at a resting position parallel to the deck 146. During a worker fall, the spooling device tray 122 rotates and maintains its position substantially parallel relative to the work deck 146 as a result of the tension of the self-retracting spooling device 114 combined with the downward momentum of the falling worker 142. It will be appreciated that the length of the safety cable 144 is important so as to pull the fall arm assembly 112 prior to the worker impacting the ground after a fall. In one non-limiting example, the length of the safety cable 144 may be up to ten feet from the axle to any given edge or opening. However, it will be appreciated that safety cable reels/spools 114 are available in various lengths (e.g., from 9 ft. to 175 ft), and the appropriately-sized safety cable 144 will be selected based upon the worker's needs.

In the event of a worker 142 fall, as shown in FIG. 10, the weight of the worker 142 falling activates the braking action of the retractable spooling device 114, if present, and further, as detailed above, the momentum of the worker's fall will tip the fall arm assembly 112 over its fulcrum 118, thereby causing the penetrating protrusions 120 to rapidly move in an arc forward and down to pierce the work deck 146 (as shown in FIG. 11), creating an additional anchorage point to impede and arrest the worker's fall.

During repositioning or hoisting of the mobile safety anchor system 100, a locking pin (e.g., bolt, cotter pin, etc.) may be inserted into an aperture 136 of the swivel boom plate 138, which mates with frame plate 140, stably arresting and securing the motion of the swivel boom 104 in one of a select number of predetermined positions.

It will be appreciated that the mobile safety anchor components are preferably fabricated primarily of steel; however, the components may also be built of other durable, hard, weather-resistant materials, including aluminum alloy, titanium alloy, or carbon composite, among others.

Exemplary embodiments are described in the preceding paragraphs. No element, act, or instruction used in this description should be construed as important, necessary, critical, or essential unless explicitly described as such. Note that although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A mobile safety anchor for use on a rooftop during construction, the mobile safety anchor comprising:
a ride-on tractor;
a swivel boom coupled to the ride-on tractor; and
a retractable safety cable coupled to the swivel boom.

2. The mobile safety anchor of claim 1, further comprising at least one arm extending from the swivel boom.

3. The mobile safety anchor of claim 1, further comprising an arm having a hinged fulcrum point and at least one penetrating protrusion.

4. A mobile safety anchor for use on a rooftop during construction, the mobile safety anchor comprising:
a ride-on tractor;
a swivel frame coupled to the chassis of the ride-on tractor;
an axle operably coupling the swivel frame to a swivel boom;
a first arm extending in a first direction from the swivel boom, the first arm comprising a counterweight at a distal end from the swivel boom; and
a second arm extending in a second, opposite direction from the first arm, the second arm comprising a fall arm assembly, the fall arm assembly comprising a retractable safety cable, a hinged fulcrum point, and at least one penetrating protrusion.

5. A method of using a mobile safety anchor on a rooftop during construction, the method comprising:
placing the mobile safety anchor on a roof or work deck, the mobile safety anchor comprising a ride-on tractor, a swivel boom coupled to the ride-on tractor, and a retractable safety cable coupled to the swivel boom;
tethering a worker to the mobile safety anchor, the mobile safety anchor anchoring the worker to the roof or work deck due to the weight of the mobile safety anchor.

6. The method of claim 5, wherein the mobile safety anchor further comprises one or more penetrating protrusions for penetrating the roof or work deck to prohibit movement of the mobile safety anchor.
